(19) United States
(12) Patent Application Publication
(10) Pub. No.: US 2004/0133429 A1
(43) Pub. Date: Jul. 8, 2004

(54) Outbound telemarketing automated speech recognition data gathering system

(76) Inventor: Donald R. Runyan, (US)

Correspondence Address: Donald R. Runyan, 18559 Dolores Avenue, Lathrup Village, MI, 48076, US

(21) Appl. No.: 10/721,619

(22) Filed: Nov. 25, 2003

Related U.S. Application Data
(60) Provisional application No. 60/430,041, filed on Jan. 8, 2003.

(51) Int. Cl. G10L 11/00

(52) U.S. Cl. 704/277

(57) ABSTRACT

An automated outbound telemarketing system and process which uses prerecorded scripts and voice recognition responses to collect data from called parties; data to be used for sales, sales leads, sales referrals, surveys, contest registration, seminar registration, and any other general or specific information dissemination and/or data collection uses.

### CROSS REFERENCE TO RELATED APPLICATIONS

This will be supplied later on forms PTO/SB/08A and PTO/SB/08B.

This application claims the benefit of the filing date of my (Donald R. Runyan) Provisional Patent, Application No. 60/430,041, filed on Nov. 27, 2002.

### DESCRIPTIVE TITLE OF THE INVENTION

The invention is titled “Outbound telemarketing automated speech recognition data gathering system”. This invention is the process of using automated speech recognition to conversationally interact with a called party to disseminate information and/or collect data.

### STATEMENT REGARDING FED SPONSORED R & D

Not Applicable

### REFERENCE TO SEQUENCE LISTING, A TABLE, OR A COMPUTER PROGRAM LISTING APPENDIX

Not Applicable

### BACKGROUND OF THE INVENTION

The need for calling people, giving information about seminars, and gathering data from people who received the information and who wished to attend the seminars sparked the initial idea to use automated speech recognition software to disseminate information and gather data. However, the first application developed, and implemented on Nov. 25, 2002, was to contact people who might be interested in getting price comparisons for their prescription medications. The process automatically dialed telephone numbers from a database of stored telephone numbers. The program managing the process recorded the call status (e.g., ring no answer, busy, answering machine, live answer, prospect, referral, etc.) and played a prerecorded script to people who answered their phones. The prerecorded script asked people if they would be interested in receiving a quote for their prescription medications. If the person answered affirmatively, they were asked to give and spell their first name, last name, give a telephone number where they could be contacted, and list their medications. If the person contacted answered that they were not interested, they were asked if they would like to refer someone who might be interested. If they answered affirmatively, they were asked to supply the referred person's name and telephone number. If the person did not wish to refer anyone, they were asked if they would like to be placed on a do-not-call list. If the person answered negatively, they were thanked for their time and the call was terminated. If they answered positively, they were asked to say their name and confirm their telephone number. They were thanked and the call was terminated. Their telephone number was then marked to comply with their wish not to be called again. This process was used to place over one million telephone calls. The innovative new system produced nearly twenty thousand positive responses using prerecorded scripts and automated speech recognition to disseminate information and gather and save data to price prescription medications for the responding people.

### BRIEF SUMMARY OF THE INVENTION

The invention is intended to replace the process of a live operator or autodialer dialing a telephone number, a live operator greeting the called party, and a live operator giving information to a called party and/or gathering and storing data from the called party, based upon the called party's responses to questions from the live operator, for any purpose including sales, sales leads, sales referrals, surveys, contest registration, seminar registration, and any other general of specific information dissemination and/or data collection uses.

### BRIEF DESCRIPTION OF THE DRAWINGS

Not Applicable

### DETAILED DESCRIPTION

This invention combines 1) a stored set of telephone numbers to be called, 2) public telephone system connection hardware, 3) a scripted call flow, 4) prerecorded audio scripts (messages and questions), 5) automated speech recognition software, 6) called party utterances (answers to questions), 7) computer stored grammars of possible called party utterance responses (answers to questions), 8) a computer program, and 9) a database for retrieved data, delivered information, and call results.

What initiates the process, is the desire of someone to reach a number of people identified by unique telephone numbers with a desire to disseminate information and/or request data from the called party. Once it is determined what information is to be disseminated and/or what data is to be gathered, 3) a scripted call flow is developed to interactively communicate with the called parties. Next 4) prerecorded audio scripts (questions and messages) are developed using live recorded voices or text-to-speech recordings. Next 9) a database is designed and created to contain retrieved data, store delivered information (including the telephone number which is delivered to the public telephone system for connection to the called party), and hold the result of the completed call (e.g., hung up, left answering machine message, ring no answer, busy, bad number, do not call, unknown/in process, transfer to live operator, prospect, referral, and fax). Next 7) computer stored grammars of possible called party utterance responses are created and stored. Next 8) a computer program to process the scripted call flow is developed. This computer program will also manage the outbound called party dialing process, using the 2) public telephone system connection hardware, so when each call is completed the next telephone number in the database will be called until all numbers have been called. Once the automated process is started, the 2) public telephone system connection hardware, under the control of the computer program, connects to each dialed telephone number in the database and the computer program records the call status in 9) a database for retrieved data (numbers, alphabetic characters, and words), delivered information, and call results. When a live party is reached, the computer program executes the call flow delivering prerecorded audio scripts (messages and questions) and executes the 5) automated speech recognition software to determine the 6) called party utterances (answers to questions) which are compared to the 7) computer stored grammars for matches. Each utterance guides the computer program to the next step in the computer program, as described in the call flow, which may be to deliver a prerecorded message or ask another prerecorded question, store the automated speech recognition result as data, ask the called party to repeat what they said (if the called party's utterance does not match the stored grammar), ask the called party to answer the previous question if the system detects no utterance from the called party, connect to the next telephone number in the database if the called party hangs up, or thank the called party and terminate the call. When the system determines an answering machine is reached, a prerecorded message may be left on the called party's answering machine, the call result (that an answering machine message was left) is recorded in the database, and the call is terminated. The detail call results are normally reported in the form of a spreadsheet or a password protected Internet accessed screen for immediate or future review.

An example of this invention would be: call a list of selected people, remind them of an upcoming meeting, deliver the content of the meeting, and ask the called party if she/he intends to attend the meeting, and record the answer for the meeting sponsors to review. Another example would be: call a specified list of people and ask them if they would be willing to contribute to a specific charitable organization. If the called person agreed to contribute, the system would capture and record the called person's name and address data, the amount to be contributed, the credit card number and the credit card expiration date. Another example would be: call a specified list of people who previously requested to be called, ask them if they are still interested in pursuing the opportunity, ask them if they have a home computer, ask them if they have Internet access and record the called party as a prospect or as not a prospect. Another example would be: call a selected list of people, ask the called party if he/she would like to speak with their state senator regarding a pending bill, and then either terminate the call or transfer the call to the senator's office. Another example would be: call a selected list of people and ask each called party his/her answers to a set of opinion survey questions.

This invention is similar in many respects to what happens when a live operator calls a person with a single purpose. What makes this invention unique is the use of automated speech recognition in outbound calling to: understand the called party's utterances (answers to questions), deliver appropriate responses (prerecorded messages or questions), deliver information (prerecorded messages), and deliver requests (i.e., ask questions) based upon the called party's utterances (Le., answers to questions).

The above described method and features should be readily apparent to those of ordinary skill in the art of telephony and automated speech recognition and they should understand that the use of automated speech recognition in outbound calling to disseminate information and/or gather data from called parties for any specific or general purpose is a unique invention.

The invention claimed is:

1. In a system including a set of stored telephone numbers, public telephone system connection hardware, a scripted call flow, prerecorded audio scripts, automated speech recognition software, called party utterances, computer stored grammars of possible called party utterances, a computer program to manage the entire process, and a database for storing data, with said system and method “wherein the improvement comprises” using a computer program to manage the process of placing outbound calls to a set of stored telephone numbers, using the public telephone system, for the purpose of contacting parties, to deliver prerecorded information to called parites and/or obtain data from called parties using automated speech recognition software to determine the called parties' responses to prerecorded questions and storing the results in a database for immediate or future review.
